(19) United States
(12) Patent Application Publication
(10) Pub. No.: US 2005/0186550 A1
(43) Pub. Date: Aug. 25, 2005

(54) System and method for dynamic electronic learning based on continuing student assessments and responses

(76) Inventor: Mubina Gillani, Coppell, TX (US)

Correspondence Address: Rick B. Yeager, 10805 Mellow Lane, Austin, TX, 78759, US

(21) Appl. No.: 11/063,781

(22) Filed: Feb. 23, 2005

Related U.S. Application Data
(60) Provisional application No. 60/546,262, filed on Feb. 23, 2004.

(51) Int. Cl. G09B 7/00

(52) U.S. Cl. 434/322

(57) ABSTRACT

A methodology is provided for using effective teaching techniques to create dynamic courses, the contents and presentation of which change based on user interaction, for use in any learning situation, such as e-learning. A user's multiple intelligences are addressed in a specific sequence and duration of interaction with various objects and media designed to engage a particular intelligence or a combination of intelligences, according to advanced theories of learning. The objects may comprise audio, video, animation, graphics, charts, community forums, text, and tools for identifying, building, and applying skills and habits, user assessments, course evaluations, and other techniques. User assessments identify relevant user information, for example, users' backgrounds, needs, styles of learning, and course accomplishments. Courses are then adapted to this user information. Students also participate in postings on community forums and complete course evaluations. Students may obtain certification, according to established educational guidelines, for completed coursework.

This application claims the benefit of PPA Ser. No. 60/546,262, filed Feb. 23, 2004 by the present inventors.

### FIELD OF THE INVENTION

The present invention relates generally to the field of interactive computer-based systems and software, and more particularly to systems and methods that provide interactive electronic learning.

### BACKGROUND OF THE INVENTION

Electronic Learning

Electronic learning (e-learning), which is training employing the Internet, is widely used to teach students a variety of subjects and skills because of its effectiveness and convenience. Computer-based materials can present large amounts of information in interesting and effective ways, and they can be used as complements to classroom courses taught by instructors or as independent modules that students can use at their convenience in settings of their own choosing. Moreover, the advent of the Internet and World Wide Web has made e-learning courses stored on a single computer available to students practically anywhere in the world. In many cases, it is more cost effective for companies and educational institutions to provide e-learning, rather than classroom instructors, for their students.

Any method of training tailored to meet the specific needs of individual students will be more effective than training that attempts to provide one method and set of materials for all students. To take a simple but crucial example, in a situation where a course is in English but the student speaks only Chinese, instruction is impossible. Even when they share a common language, students are individuals with different backgrounds, perspectives, and ways of learning. Therefore, methods have been devised to provide interactive e-learning that responds in various ways to information provided by students.

For example, U.S. Pat. No. 6,236,955, to Summers, MANAGEMENT TRAINING SIMULATION METHOD AND SYSTEM, provides a management training simulation system to develop decision-making skills in a simulated situation, where user assessments cause object designs to be injected into the simulation.

U.S. Pat. No. 6,134,539 to O'Connor et al., METHOD AND ARTICLE OF MANUFACTURE FOR GOAL BASED EDUCATION AND REPORTING SYSTEM, teaches an interactive, e-learning method that provides simulated environments with video and graphics and dynamic feedback that notes users' mistakes and presents remedial instructional material.

U.S. Pat. No. 5,310,349 to Daniels et al., INSTRUCTIONAL MANAGEMENT SYSTEM, teaches a virtual school interface on networked personal computers to provide administrative and instructional functions to users in a simulated scholastic environment, where users can interact with each other and with system elements.

U.S. patent application No. 20030162159 for Sheehan, MODULAR COMPUTER-BASED TRAINING SYSTEM, teaches a method for training users where a programmed computer controls the path of learning and the user controls the pace of learning.

U.S. patent application No. 20030008266 for LoSasso et al., INTERACTIVE TRAINING SYSTEM AND METHOD, teaches a method that allows efficient creation, implementation and utilization of interactive training modules and/or scenarios, with customization of content through ratings from users and with a database that collects and stores data concerning the interactions of individual users with individual scenarios.

However, existing e-learning systems do not fully employ modern cognitive theory to adequately understand and respond, during the training, to individual students' needs and ways of learning. Therefore, there is a need for a system and method that provides concrete, interactive e-learning founded on modern cognitive theory and continuing student assessments and responses.

### BRIEF SUMMARY OF THE INVENTION

These and other needs are addressed by the present invention. The following explanation describes the present invention by way of example and not by way of limitation.

It is an aspect of the present invention to provide a system and method for dynamic courses based on customer assessments.

It is an aspect of the present invention to provide a system and method for dynamic e-learning courses based on customer assessments.

It is another aspect of the present invention to provide interactive tailoring of courses by learning styles according to cognitive theory.

It is another aspect of the present invention to provide a method for certification by community colleges for students who have completed e-learning.

It is another aspect of the present invention to provide a method for storing and accessing data for e-learning.

These and other aspects, features, and advantages are achieved according to the system and method of the present invention. In accordance with the present invention, a methodology is provided for using effective teaching techniques to create dynamic courses, the contents and presentation of which change based on user interaction, for use in any learning situation, such as e-learning. A user's multiple intelligences are addressed in a specific sequence and duration of interaction with various objects and media designed to engage a particular intelligence or a combination of intelligences, according to advanced theories of learning. The objects may comprise audio, video, animation, graphics, charts, community forums, text, and tools for identifying, building, and applying skills and habits, user assessments, course evaluations, and other techniques. User assessments identify relevant user information, for example, users' backgrounds, needs, styles of learning, and course accomplishments. Courses are then adapted to this user information. Students also participate in postings on community forums and complete course evaluations. Students may obtain certification, according to established educational guidelines, for completed coursework.

### BRIEF DESCRIPTION OF THE DRAWINGS

The following embodiment of the present invention is described by way of example only, with reference to the accompanying drawings, in which:

FIG. 1 is a block diagram showing an operating environment in which embodiments of the present invention may be employed;

FIG. 1A is a block diagram showing an example of profiles that may be stored in the profiles area in storage.

FIG. 1B is a perspective view showing an example of a user profile that a user would fill out.

FIG. 2 is top-level flow chart that illustrates a process for setting up and deploying an e-learning system;

FIG. 3 is a perspective view that illustrates the layout of a course in an embodiment;

FIG. 4 is a perspective view that illustrates some of the objects used in a typical course in an embodiment;

FIG. 5 is a perspective view that illustrates a community forum used as a chat room for postings in an embodiment;

FIG. 6 is a perspective view that illustrates an Experience Chart in an embodiment; and

FIG. 7 is a perspective view that illustrates a Habit Chart in an embodiment.

FIG. 8 is a block diagram that illustrates an example of a typical computer system

FIG. 9 is a representation of a screen presenting the overview and objectives of a course.

FIG. 10 is a representation of a screen presenting a pre-assessment of a course.

FIG. 11 is a representation of a screen presenting content for a course on HIPAA Privacy Regulations.

FIG. 11A is a representation of a screen presenting skills to develop, from which the student can choose areas that meet his needs and interests for a course on HIPAA Privacy Regulations.

FIG. 12 is a representation of a screen presenting a community forum input page for a course on HIPAA Privacy Regulations.

FIG. 13 is a representation of a screen presenting postings in the community forum for a course on HIPAA Privacy Regulations, from which the student can select forum topics.

FIG. 14 is a representation of a screen presenting the discussion threads available for a forum topic.

FIG. 15 is a representation of a screen presenting an Experience Chart for a course on HIPAA Privacy Regulations.

FIG. 16 is a representation of a screen presenting a Habit Chart for a course on HIPAA Privacy Regulations.

FIG. 17 is a representation of a screen presenting a confirmation of completion for a course.

FIG. 18 is a representation of a screen presenting an online evaluation of a course.

FIG. 19 is a representation of a screen presenting technical and support questions.

### DETAILED DESCRIPTION

The following description is offered to illustrate the present invention clearly. However, it will be apparent to those skilled in the art that the concepts of present invention are not limited to these specific details. Commonly known elements are also shown in block diagrams for clarity, as examples and not as limitations of the present invention.

Operating Environment

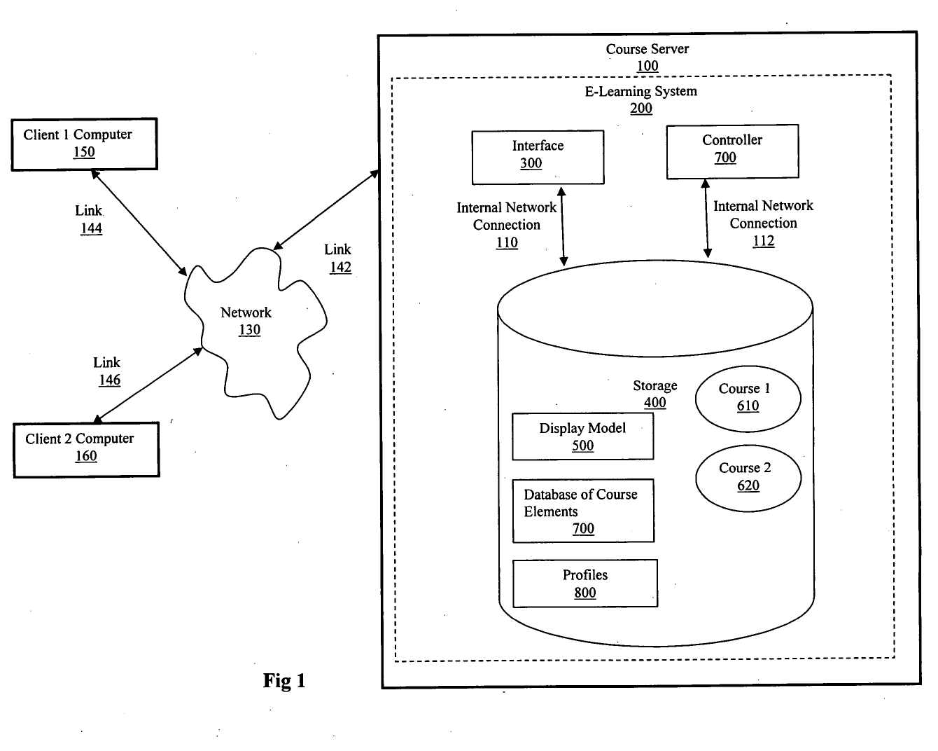

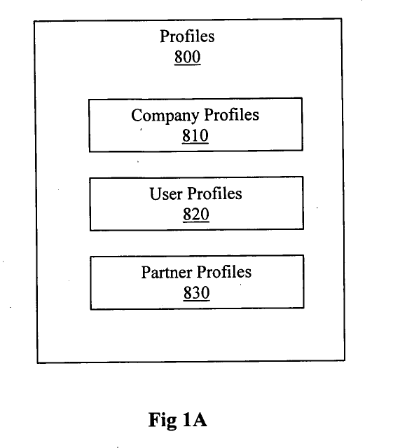

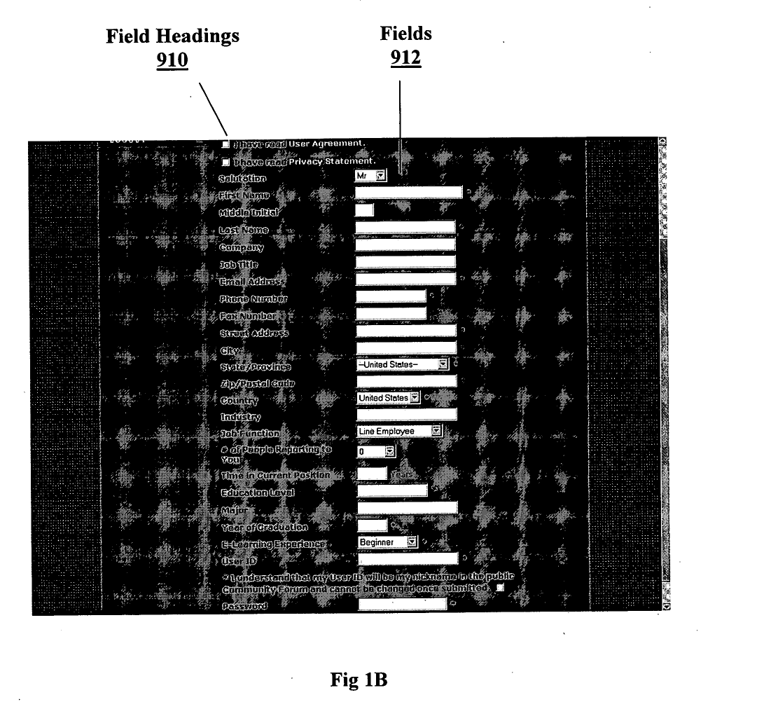

An embodiment of an operating environment of the present invention is shown in FIG. 1. A provider employs a course server 100 to make available to clients one or more computer-based courses 610 and 620, which may or may not be related. The course server 100 may be a personal computer or a larger computerized system or combination of systems.

One or more clients employ one or more computers 150 and 160 to communicate over wired or wireless link links 144 and 146, a wired or wireless link communications network 130, and a wired or wireless link 142 with the course server 100. The client computers 150 and 160 may be personal computers or computerized systems or combinations of systems comprising servers, for example.

The network 130 may be the Internet, a private LAN (Local Area Network), a wireless network, a TCP/IP (Transmission Control Protocol/Internet Protocol) network, or other communications system, and may comprise multiple elements such as gateways, routers, and switches.

To accomplish e-learning in one embodiment, course server 100 employs an e-learning system 200, comprising the following elements, explained in detail below:
an interface 300,
two internal network connections 110 and 112,
at lease one controller 170
storage 400,
a display model 500,
one or more courses 610 and 620,
a database of course elements 700, and
profiles 800.

The interface 300 may be portal Web page that allows users to access the e-learning system 200.

The display model 500 is a software program that contains the data necessary to provide a view of course pages.

The database of course elements 700 is used to store the elements used in each course for further use with different courses, as explained below.

The profiles 800 are used to store business information about the users and sales partners associated with e-learning system 200. For example, FIG. 1A shows an example of profiles that may be stored in an embodiment, comprising
Company profiles 810 containing data about businesses. For example, a company may contract for courses for its employees, or a community college may contract for its students.
User profiles 820 containing data about individual users. FIG. 1B shows an example of a user profile that a user would fill out. This user profile comprises field headings 910 indicating the information to be supplied, for example the users name and address, and fields 912 in which to enter that information.
Partner profiles 830 containing data about partners that sell the services of the e-learning system.

In an embodiment, the following items are encrypted in profile information:
E-mail address
Phone number
Fax Number
Street Address, City, State, Zip, Country
Password
Social Security Number
Student Id

The controller 170, shown in FIG. 1, determines the start of a user session and delivers information to the right locations at the right time. In a complex embodiment, multiple controllers are employed.

In another embodiment, e-learning system 200 could be developed on one server 100 and then could be loaded on another server, such as computer 150, for use there.

In an embodiment, the elements of e-learning system 200 comprise a discrete system, but in other embodiments they can be distributed more loosely throughout the operating environment, on more than one server, as necessary and advantageous. For example, the interface 110 could be on one server 100 and the courses 610 and 620 could be on servers 100 and 150.

Process

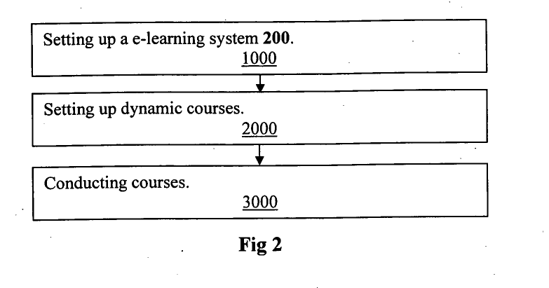

FIG. 2 is top-level flow chart that illustrates a process for x through the operating environment shown in FIG. 1. It will be useful to explain the steps in this process briefly from a high level and then to expand elements of this explanation in detail.
Setting up a e-learning system 200;
Setting up dynamic courses; and
Conducting courses.
   Setting Up an E-learning System
   Software Tools for Setting Up the Present Invention

In an embodiment, the following software tools may be used to create elements of the present invention:
Java, J2EE platform, Java generic objects
Eclipse Platform—to generate documentation. The Eclipse Platform is an open platform for tool integration built by an open community of tool providers and is designed for building integrated development environments for Web sites, Java™ programs and other technologies. The Eclipse Foundation is a non-profit corporation formed to advance the creation, evolution, promotion, and support of the Eclipse Platform.
Html files to document all components
   Setting Up Dynamic Courses
   Overview

The present invention provides a methodology for using effective teaching techniques to create dynamic courses, the contents and presentation of which change based on user interaction. This methodology is applicable to e-learning as well as to traditional methods of learning via classrooms, Computer Based Training (CBT), or other means.

To make the learning experience effective, this methodology addresses a learner's multiple intelligences in a specific sequence and duration of interaction with various objects and media designed, assembled, and displayed to engage a particular intelligence or a combination of intelligences, according to advanced theories of learning. The objects may comprise, but are not limited to audio, video, animation, graphics, charts, community forums, text, and tools for the active application of skills, the assessments of users, and the evaluations of courses. These objects are combined, ordered, and presented in a specific sequence useful for developing any course that a person would take.

In an embodiment, this methodology enables the development of a form of e-learning that is simpler in presentation, more universally understandable and more effective for the human-mind to absorb, understand. This e-learning is based on learning through users' concrete, interactive experiences.

As part of the training process, users participate in systematic assessments to identify information about those users, for example, their backgrounds, needs, styles of learning, and course accomplishments. The courses that users' take are adapted systematically to this information to make the users' learning experiences effective. For example, a course may be tailored to meet a user's needs according to the user's culture, language and style of learning. A lesson may be repeated in a different way if a user has not fully mastered its content. The senses of sight and sound are incorporated with interactive discussions as well as humor to make courses relevant as well as entertaining. Practical tools to target specific skills are provided to help develop effective habits.

Students also participate in group learning through postings on community forums for particular courses and complete evaluations of courses.

Technical and content experts are used to develop and maintain the effectiveness of content and delivery of courses that employ the present invention's framework.

In an embodiment, students of the present invention's method may obtain certification, according to established educational guidelines and procedures, for coursework they have completed.

Incorporate Effective Teaching Techniques

The following are examples of teaching techniques of proven effectiveness that are employed in an embodiment an embodiment of the present invention.
Cognitive theories of multiple intelligence and emotional intelligence
Humor, philosophy,
Hands-on experience
Habit-building opportunities
Interactive dialogue
   Cognitive Theories of Multiple Intelligence and Emotional Intelligence
   The Eight Intelligences

In an embodiment, the present invention employs the theory of eight intelligences as an example of a useful cognitive theory of learning, with the understanding that the precise number and definition of intelligences identified by this theory are only guidelines that may be modified by additional research.

It has recently been documented that a human mind uses multiple intelligence and that the traditional notion of intelligence based on the Intelligent Quotient (IQ) is not broad enough to allow for effective teaching. In 1983 in his book Frames of Mind, Dr. Howard Gardner, a professor of education at Harvard University, proposed eight different intelligences to account for a broader range of human potential and ways of learning:
Linguistic
Logical-mathematical
Spatial
Bodily-Kinesthetic
Musical
Interpersonal
Intra-personal
Naturalist

The theory of multiple intelligences suggests that training be presented through different tools focused on the ways that particular students go about learning, such as
Words (linguistic intelligence)
Numbers or logic (logical-mathematical intelligence)
Pictures (spatial intelligence)
Music (musical intelligence)
Self-reflection (intrapersonal intelligence)
A physical experience (bodily-kinesthetic intelligence)
A social experience (interpersonal intelligence), and/or
An experience in the natural world. (naturalist intelligence)

To take a simple example, one student might learn best through written words, another through pictures. In addition, combinations of training tools appropriate to intelligences a particular student has developed may be particularly effective techniques.

The eight different intelligences are now considered the base on which learning needs to take place. The application of this research is just now beginning to make an impact in traditional teaching within the K-12 industry.

Content of Courses

In an embodiment, courses are written by subject matter experts and academic professionals using publicly available and documented best practices as reference material and regulations developed by the appropriate governing agency. The objectives and requirements for successful completion of courses are clearly stated in the overview section at the beginning of each course.

Structure of Courses

Assessments
Online assessments are conducted to determine students' backgrounds, needs, styles of learning, and course accomplishments.
Postings
Students can read and post messages about their course on community forums, to provide opportunities for group learning.
Course Evaluations
Students are given opportunities to evaluate the courses they have taken.
Skill Selection
At the end of each lesson in a course, the student selects a skill to develop. An experience chart then appears, to explain a plan for gaining the skill. Subsequently a habit-building chart appears, showing, for example, a time span for obtaining the skill.

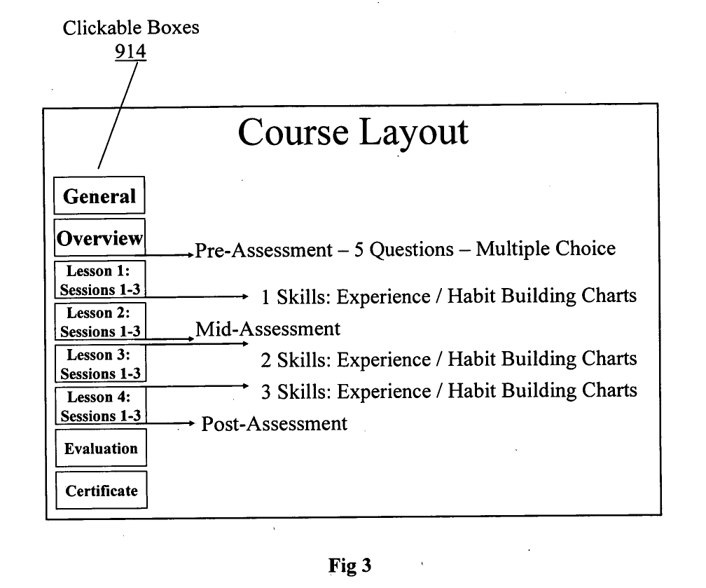

FIG. 3 illustrates the typical Web page layout of a course, in an embodiment, comprising boxes 914 on which the user can mouse click to assess information.

Multimedia Objects Used in Courses

In an embodiment, the following educational objects or techniques are used to make courses interesting and effective:
Flash media is used throughout the course to demonstrate practical applications of the regulations in an entertaining way.
Animations are used as illustrations of analogies.
Animated characters that fit industry profiles role play situations, interacting with student responses.
For example, in an embodiment animated characters may comprise
   An entrepreneur
   A psychologist
   An interviewee
   A manager
   A customer service representative
   An old man
   A dancer
   A Chinese helper
   An Indian helper
   A volunteer
   A coach
   A lioness
   A stressed bunny
Visual graphics are used with games and check-off boxes.
Videos are used to illustrate concepts in each course.
Threaded Dialogs
These are used to create repositories of learning. To participate in threaded dialogs, students perform the following steps:
   Entering an answer to a topic question; and
   Viewing and replying, or posting to a minimum number of topics for certification.

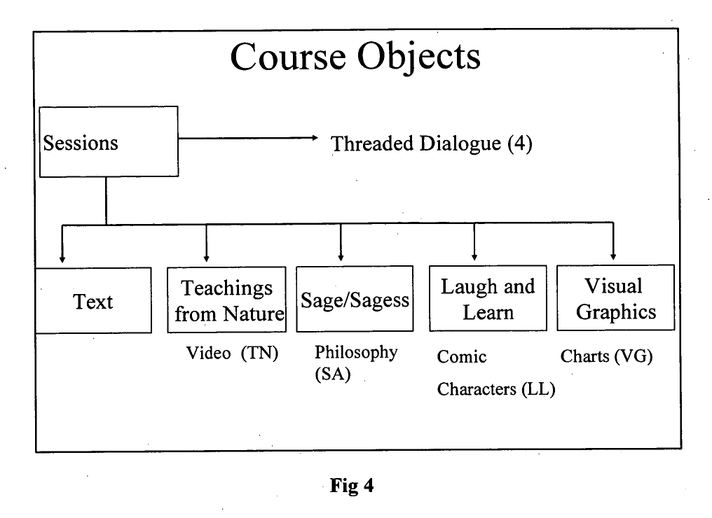

FIG. 4 illustrates the use of some of these objects in a typical course, in an embodiment. Note that this is not a screen that the user sees. The elements represent each component of a graphic, video, animation, threaded dialogue, skill identification, experience and habit building charts, assessments, evaluation, and textual concepts that are configured in a unique manner to leverage the theory of multiple intelligences and fully engage the learner in the act of internalizing the concepts presented in the lessons.

Duration of Courses

In an embodiment, each course is measured in terms of clock hours and, once started, must be completed in six weeks (This may vary based on the length of the course.). A learner is advised to spend fifteen to thirty minutes a day, five days a week to complete the course.

Certification

The methodology of the present invention may be adapted to provide certification for student coursework through multiple certification agencies. For example, community colleges may help develop online courses and certification standards for those courses.

In an embodiment, the present invention's online methodology is designed using the International Association for Continuing Education Training (IACET) requirements for granting traditional Continuing Education Units (CEUs) as well as best practices in instructional design including a structured use of multiple intelligences. Students are required to complete the following steps to receive CEUs:
Take three assessments.
Do two a minimum number of two postings.
Respond to a minimum number of two postings.
Enter a skill or a habit to develop in each lesson.
Take evaluations.
   Assessments and Evaluations

In an embodiment, the following three scored assessments are conducted as part of each course:
Pre-assessment
Mid-assessment
Post-assessment—This is conducted after a student takes a course. It involves
An evaluation of the course—This is done after the post-assessment and includes
   Questions about the course's content, for example questions about understanding of concepts and the sharing of information in the community forum; and
   Technical questions about the user's ease with using the technology of the course, covering, for example, the navigation, videos, animations, community forum, and interaction with visual graphics.

These assessments require learners to critically think through their responses using best-option scenarios rather than memorization of content material. In different embodiments, the pass rate for certification can be set by the sponsoring/partnering institution or may default to a pass-rate of 70%. To meet the requirements for granting CEUs, assessment questions are tied directly to the course objectives.

Postings

Students can read and post messages about their courses in community forums.

Course Evaluations

Students are given opportunities to evaluate the courses they have taken.

Storing and Accessing Course Data as Building Blocks for Other Courses

The specific elements used in each course are stored in a database of course elements 700 in storage 400, shown in FIG. 1, and referenced as unique components that can be accessed through metadata for use with different courses. For example, each paragraph of text, video, piece animation, simulation, and audio file in a course may be stored and referenced for use with other courses.

Applications of Dynamic Learning

The following are examples of applications where embodiments of the present invention may be employed effectively:
Community college courses,
Company-specific courses, on a company server,
Courses accessible to a common server, in a company-specific section,
Online regulatory courses for health care and child care, and
Online courses for leadership.
   Example of Course Scenario

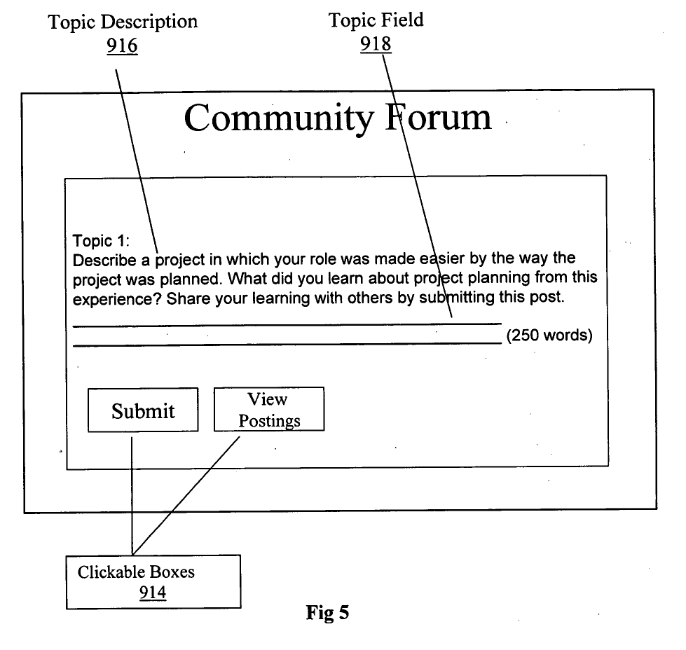

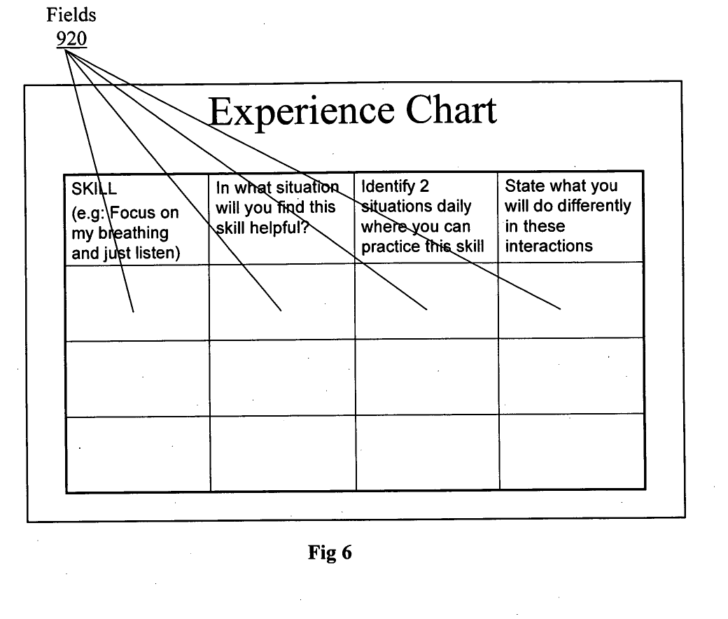

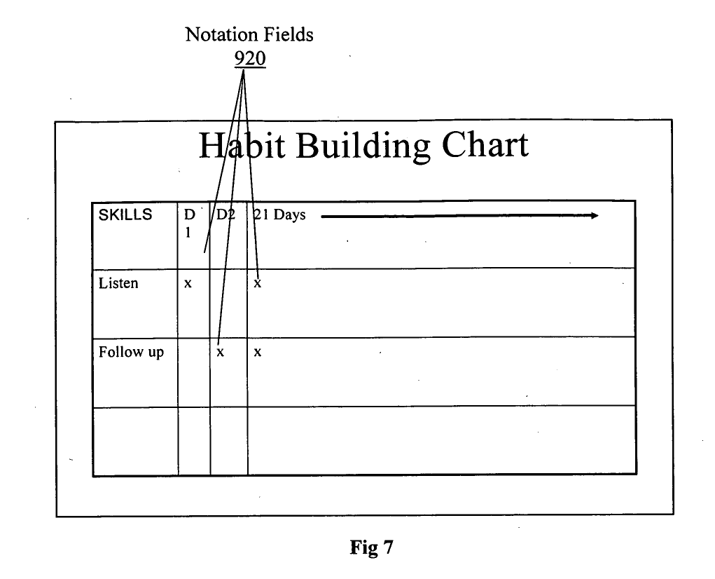

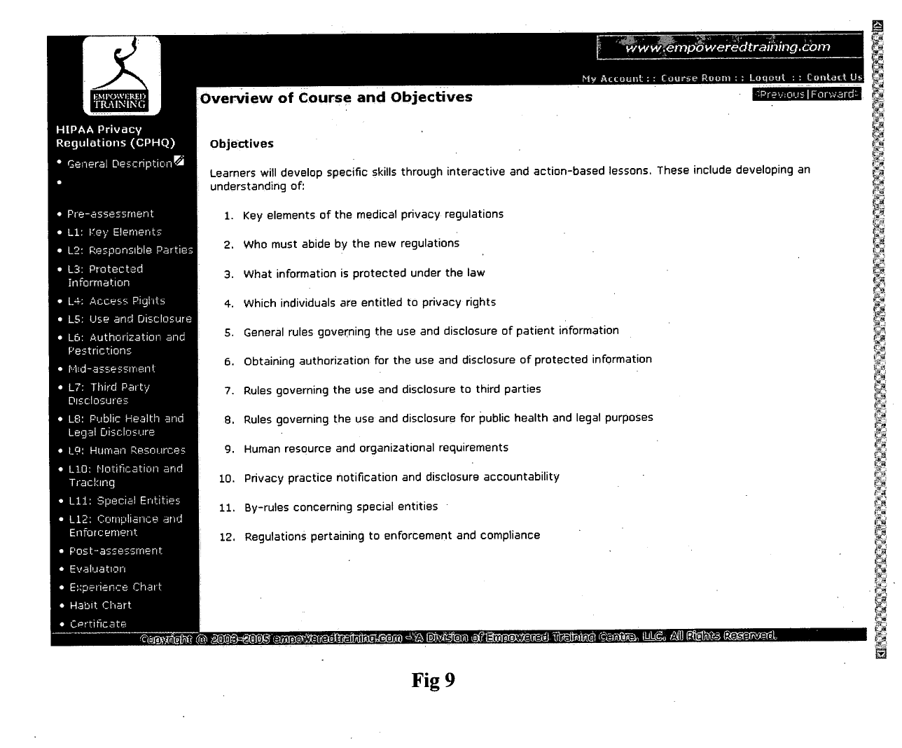

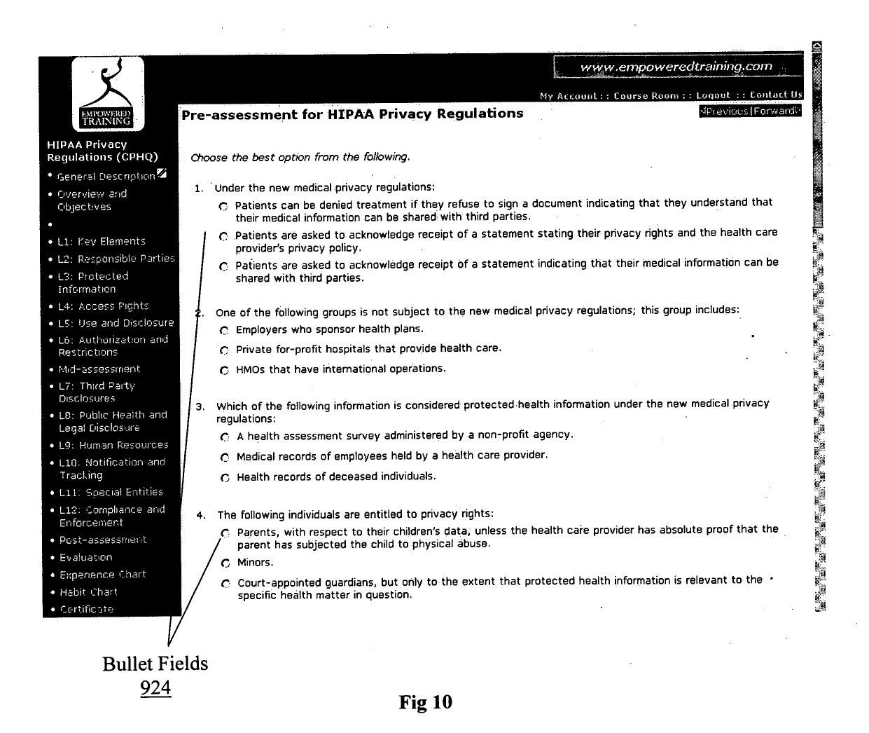

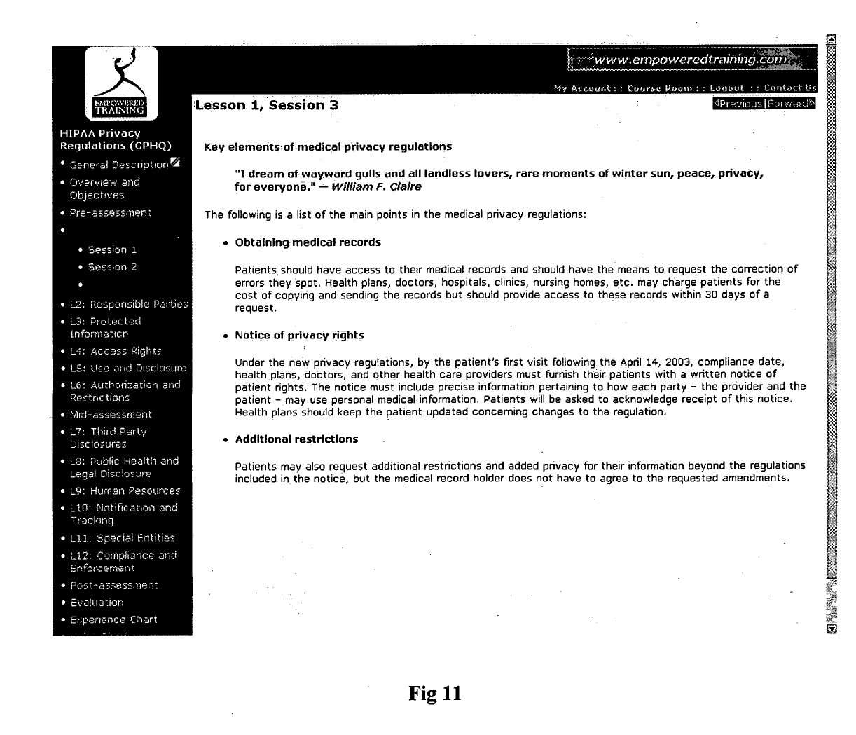

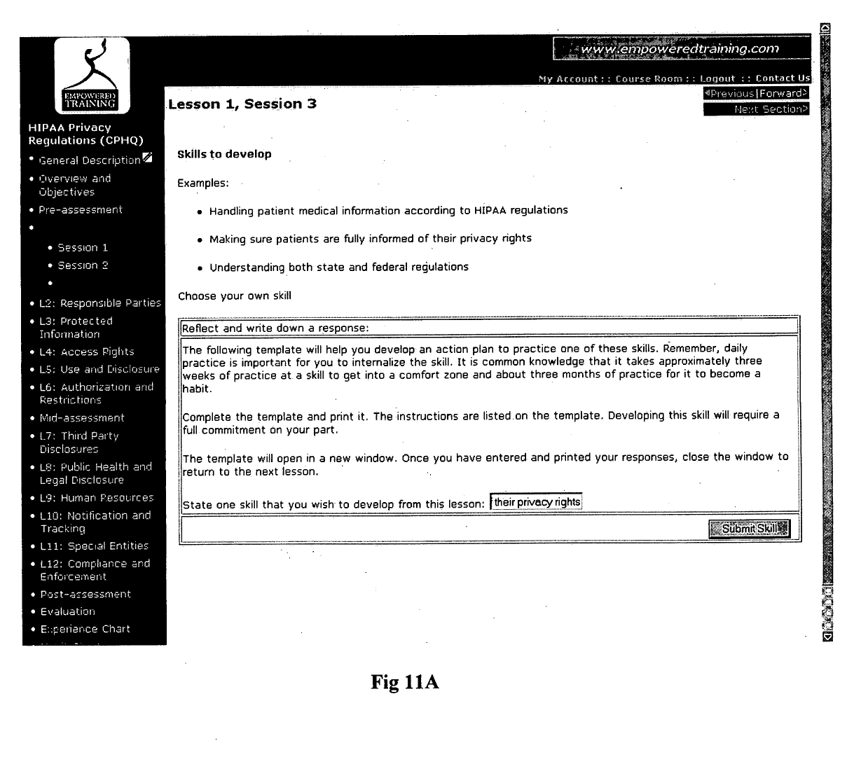

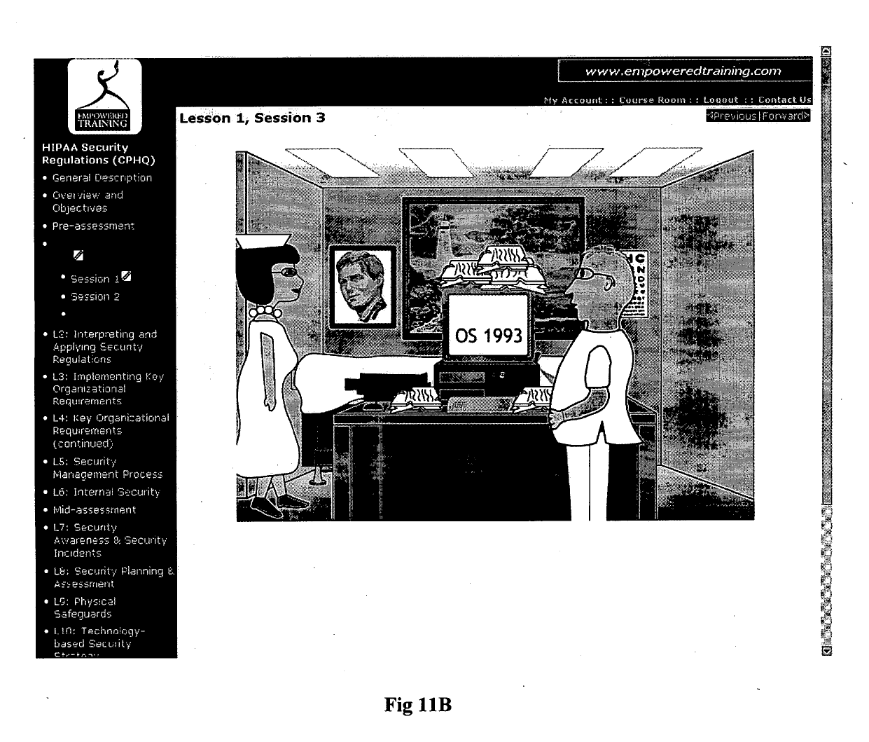

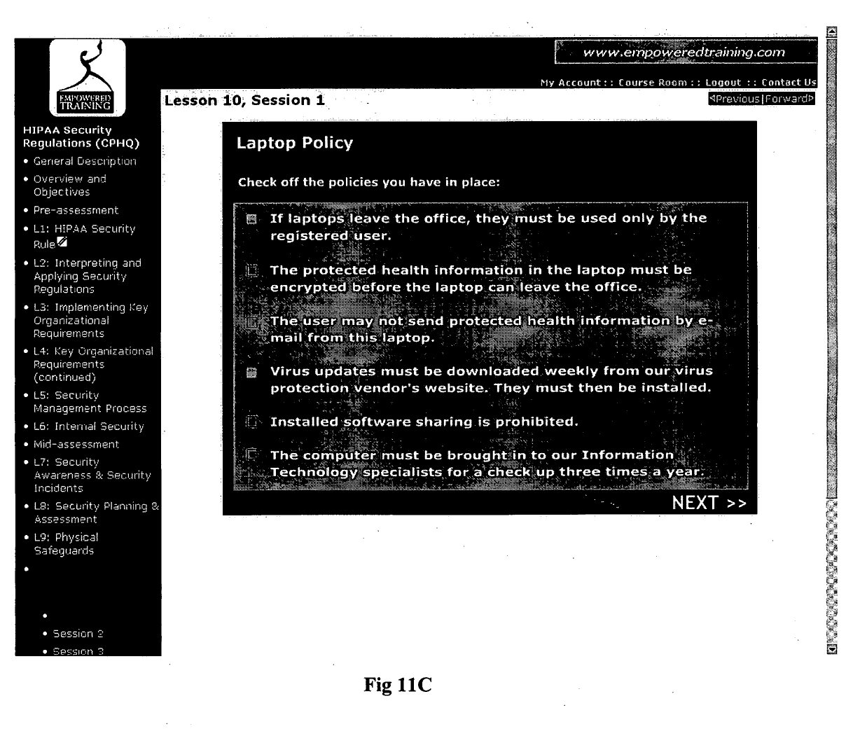

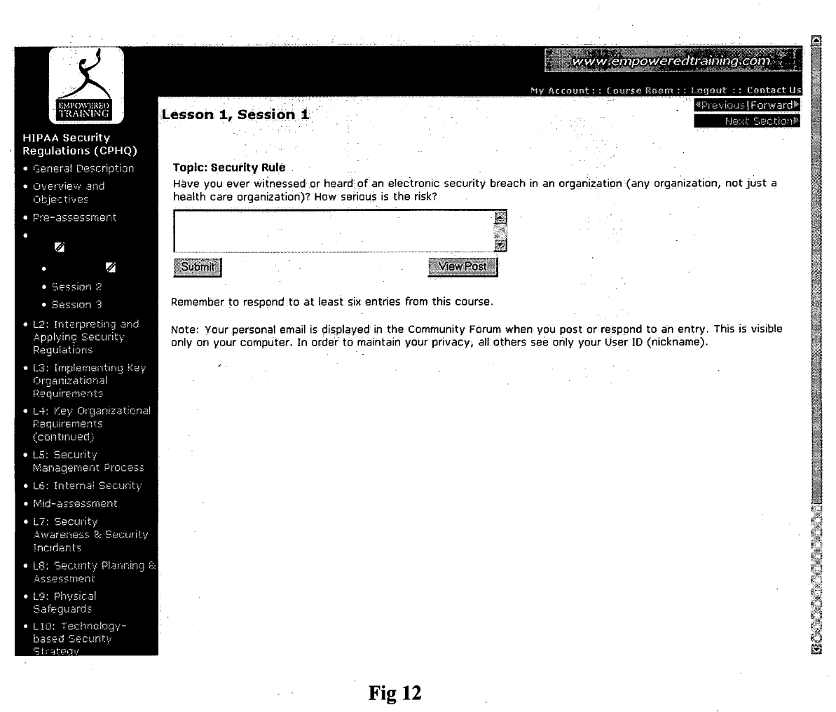

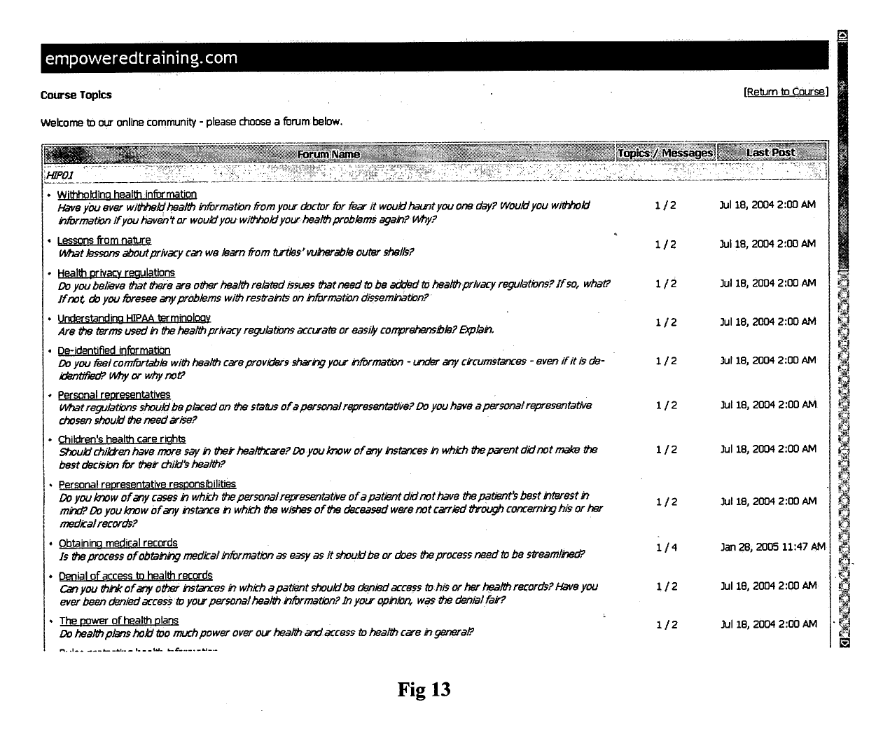

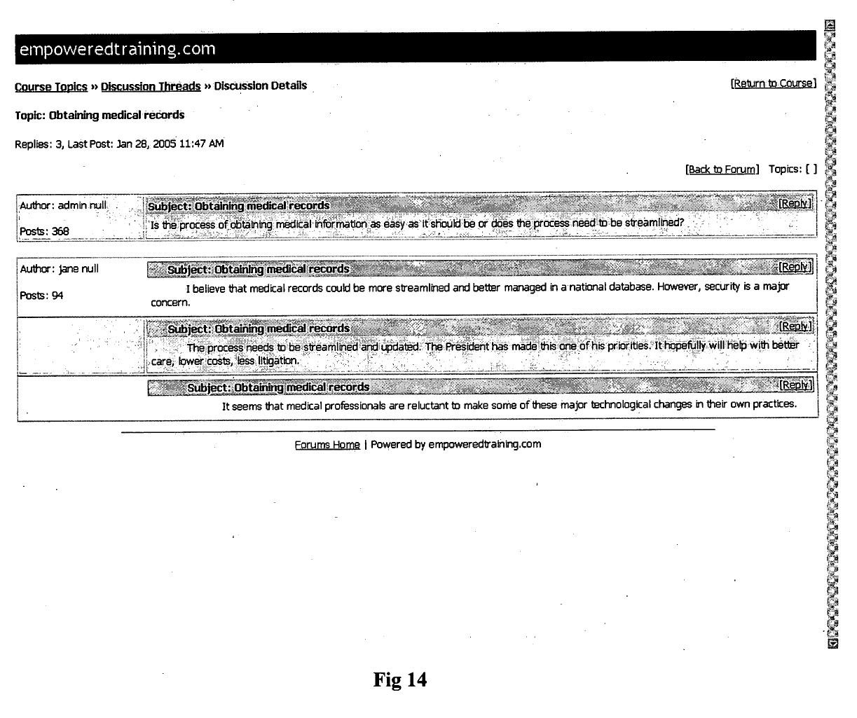

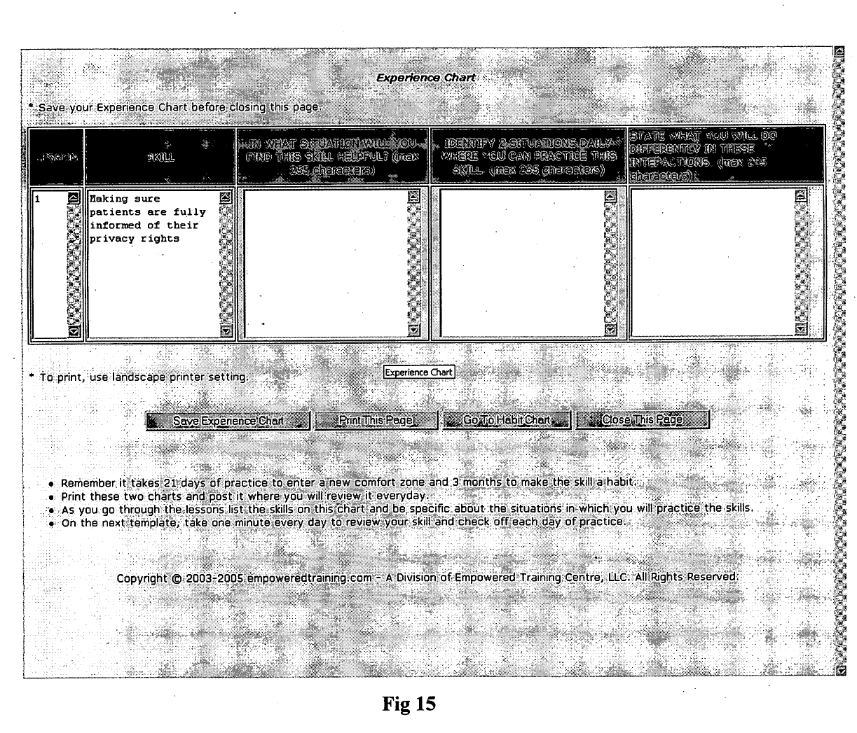

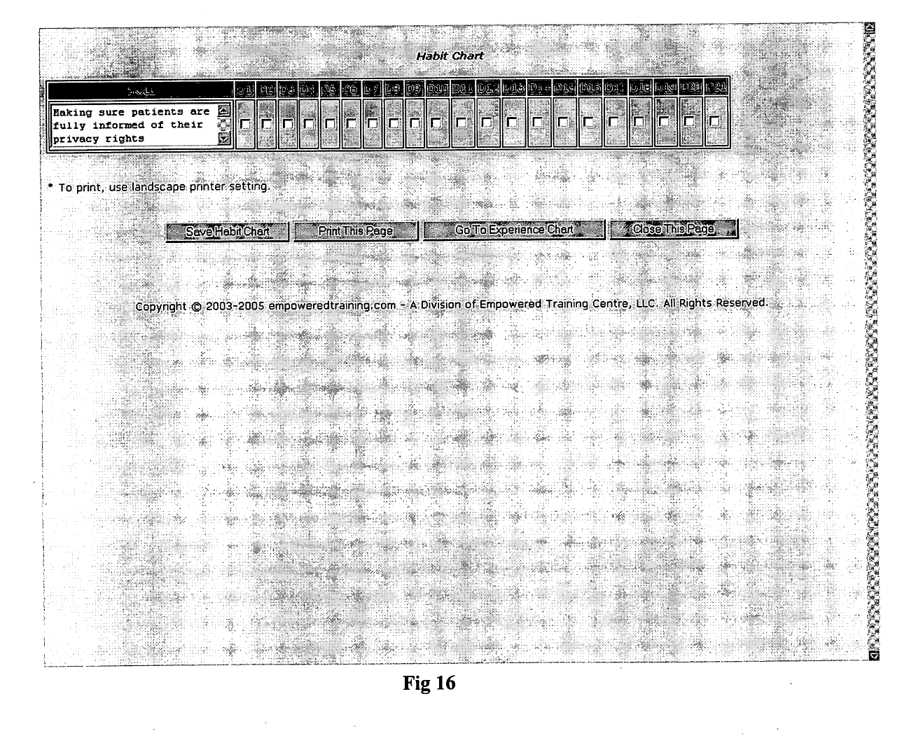

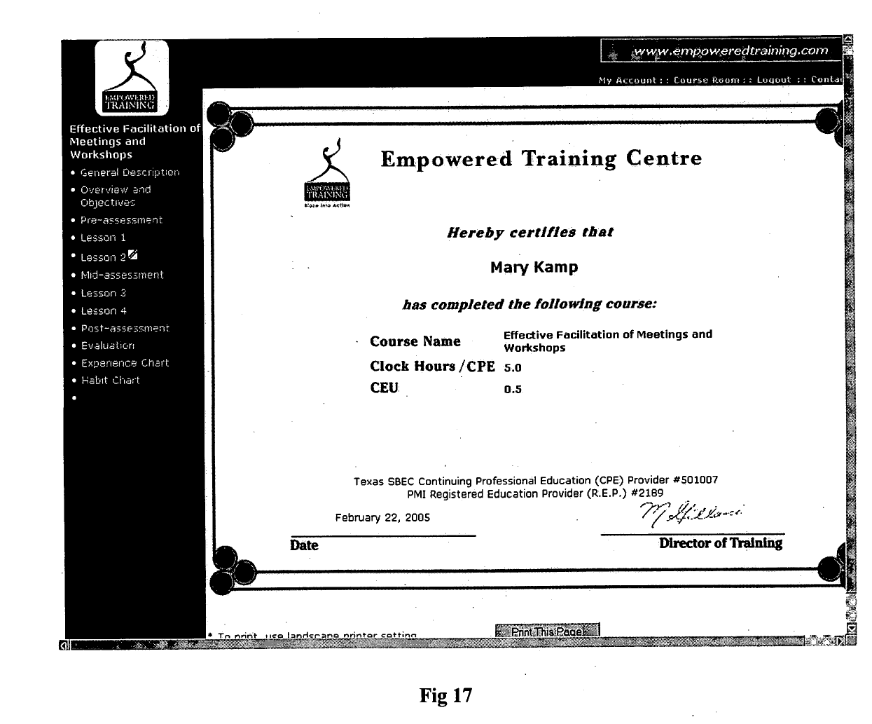

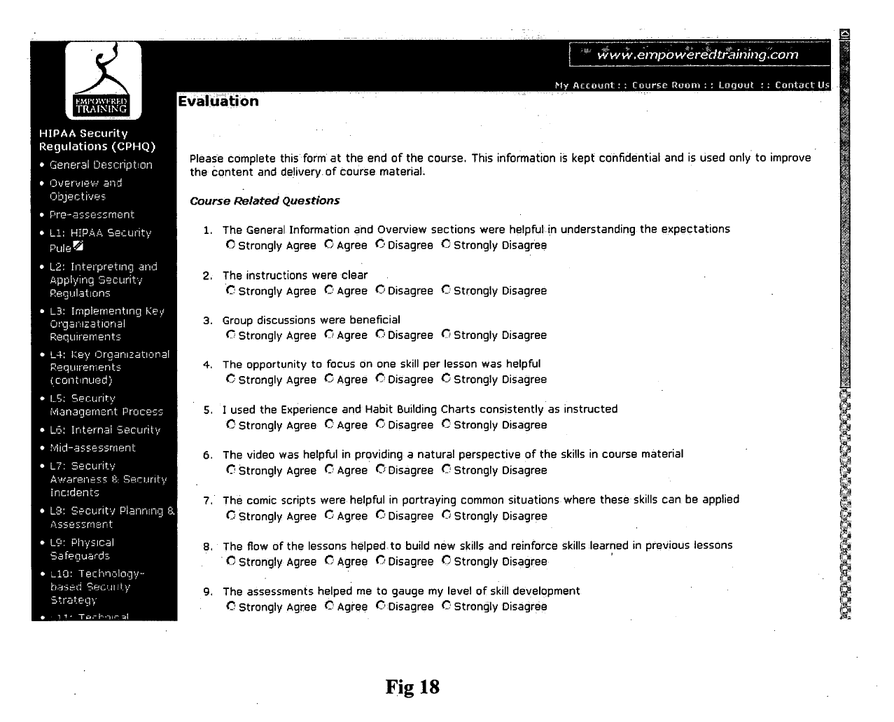

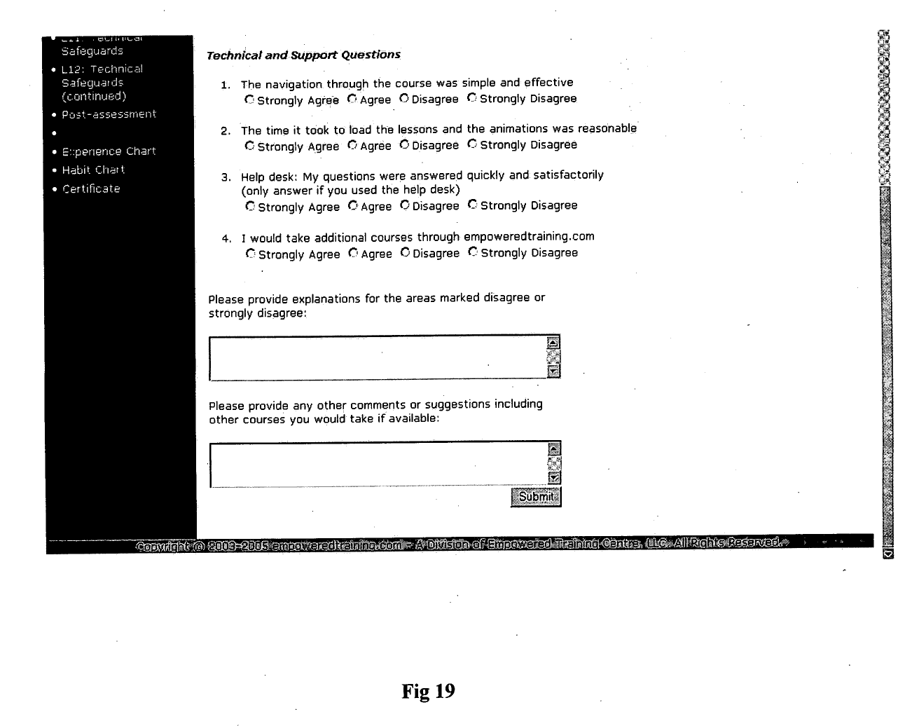

The follow scenario is an example of the steps used in an embodiment of the present invention.
1. A B2C (business to customer) learner fills out a user profile and purchases a course online with a credit card, and the course is placed in his schedule of courses. FIG. 1B shows an example of a user profile.
2. The learner begins the course and goes through a general description of the course, expectations, overview, and objectives of the course. FIG. 9 shows an example of a screen presenting the overview and objectives of a course on HIPAA (Health Insurance Portability and Accountability Act) Privacy Regulations.
3. The learner completes the pre-assessment (each question is linked to a specific objective/skill) and gets his scores for each question and the total score. This tells him what his strengths and weaknesses are. FIG. 10 shows an example of the first screen presenting a pre-assessment for the course on HIPAA Privacy Regulations, with bullet fields that the user can mouse click on to supply requested information. In an embodiment, the presentation of the course is adapted dynamically based on this user input.
4. The learner begins the course at lesson 1, session 1 and completes the full course, regardless of his mastery level. FIG. 11 shows an example of a screen presenting content for the course on HIPAA Privacy Regulations. FIG. 11A shows an example of a screen presenting skills to develop from which the student can choose areas that meet his needs and interests, for the course on HIPAA Privacy Regulations
5. Within each lesson (chapter), the learner goes through the following sequence:
   Presentation of the lesson/session objective (multiple intelligence components: linguistic, logical-mathematical), with presentation in text and voice-over for the concepts.
   Analogies of the concept are presented using nature videos (multiple intelligence components: naturalist) and laugh-and-learn animated situational depictions (multiple intelligence components: linguistic, interpersonal intelligence, spatial and musical).
   Internalization of the concept and analogy using self reflection through visual graphics (simulations of games, checklists, etc) (multiple intelligence components: intrapersonal, bodily-kinesthetic, spatial, logical-mathematical, linguistic, and musical).
   FIG. 11B shows an example of a screen presenting humorous graphics for the course on HIPAA Privacy Regulations. FIG. 11C shows an example of a screen presenting a checklist for the course.
   Communication in a chat room by posting responses to topic questions from the instructor and sharing of best practices (multiple intelligences: interpersonal, linguistic, and logical-mathematical).
   FIG. 5 shows a screen for a community forum input page used for postings in such a chat room, in an embodiment. This community forum input page comprises a topic description 916, which requests information about the course and a topic field 918, in which the user can enter the requested information. The community forum input page also comprises clickable boxes 920 on which the user can mouse click to accomplish actions, to submit entered information and to view postings by students.
   FIG. 12 shows an example of a community forum input page for the course on HIPAA Privacy Regulations. FIG. 13 shows a screen of postings in the community forum for the course on HIPAA Privacy Regulations, from which the student can select forum topics. FIG. 14 shows some of the discussion threads available for one such forum topic, “Obtaining medical records.”
   Summarization of concepts in the lesson/session (multiple intelligence components: linguistic, logical-mathematical).
   At the end of each lesson, identification of a specific skill by the learner (from the concepts presented in the lesson) that the learner needs to develop on an online ‘Experience Chart.’ Through the Experience Chart, the learner is guided to build a personal plan that will help them over a course of twenty-one days to change a habit or develop the identified skill. FIG. 6 shows an Experience Chart, in an embodiment, with fields 920 on which students can enter requested information. The skills are pulled in automatically from the completed experience chart and the learner can check off the boxes online and save the information. This allows the learner to track his practice history for the skill or habit he identified.
   FIG. 15 shows an Experience Chart for the course on HIPAA Privacy Regulations.
   The Experience Chart can be printed and a “Habit Chart is automatically produced with the skills identified that helps them record action for twenty-one days. (Multiple intelligences used: linguistic, logical-mathematical, spatial, and intrapersonal). FIG. 7 shows a Habit Chart, in an embodiment, on which the student can enter data in notation fields 920. FIG. 16 shows a Habit Chart for the course on HIPAA Privacy Regulations.
   After successfully completing a course, a student may receive a printable confirmation of completion, as shown in FIG. 17.
   The student is subsequently given the opportunity to complete an online evaluation of the course, as shown in FIG. 18. The student can also complete an online form about technical and support questions concerning his ease of use with the course, as shown in FIG. 19.
6. Each subsequent lesson/session has the same methodology. Some courses may have five lessons, others fifteen.
7. Companies that purchase a license can provide the capability of just-in-time training (embedded learning) to their employees (access to one small component whenever the need arises). For example, if three months after finishing a course a learner comes across a situation and has forgotten what to do, the learner can access the lesson on that situation because the link to the lesson is embedded within the user's workflow. Multiple languages and customized selection of lessons/animations are made available based on the user profile and the manner in which the content resides on the database.
   Computer System Overview

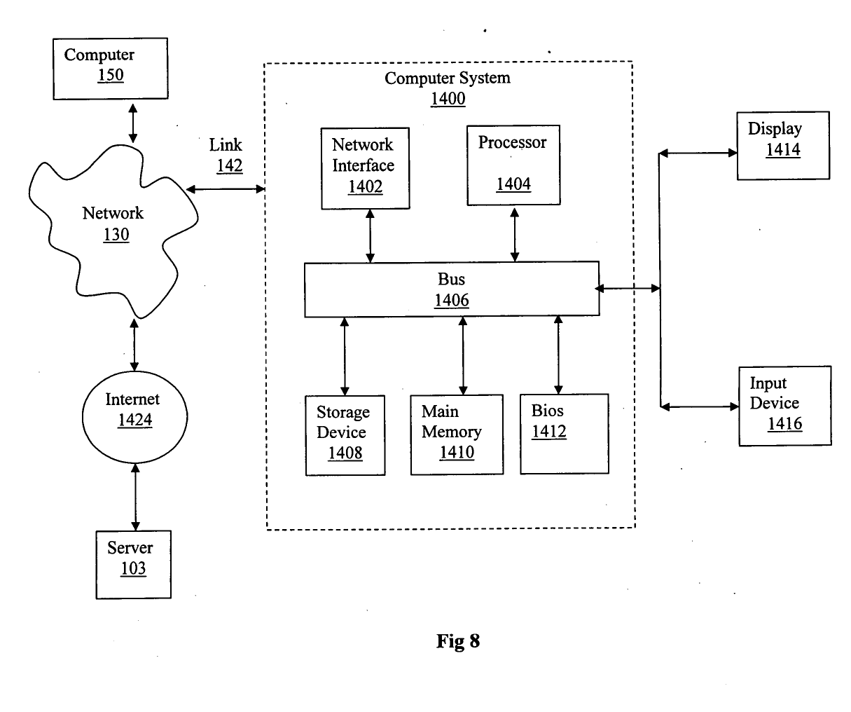

FIG. 8 is a block diagram that illustrates an example of a typical computer system 1400, well known to those skilled in the art, representing a server 100 on which embodiments of the present invention can be implemented. This computer system 1400 comprises a network interface 1402 that provides two-way communications through a wired or wireless link 142 to a wired or wireless communications network 130 that uses any applicable communications technology. For example, the network 130 can comprise a public telephone network, a wireless network, a local area network (LAN), and any known or not-yet-known applicable communications technologies, using correspondingly applicable links. The network 130 in turn provides communications with one or more host computers 150 and, through the Internet 1424, with one or more servers 103.

The network interface 1402 is attached to a bus 1406 or other means of communicating information. Also attached to the bus 1406 are the following:
a processor 1404 for processing information;
a storage device 1408, such as an optical disc, a magneto-optical disc, or a magnet disc, for storing information and instructions;
main memory 1410, which is a dynamic storage device such as a random access memory (RAM) that stores information and instructions to be carried out by processor 1404;
a bios 1412 or another form of static memory such as read only memory (ROM), for storing static information and instructions to be carried out by processor 1404;
a display 1414, such as a liquid crystal display (LDC) or cathode ray tube (CRT) for displaying information to user of the computer system 1400; and
an input device 1416, with numeric and alphanumeric keys for communicating information and commands to processor 1404. In another embodiment a mouse or other input devices can also be used.

The computer system 1400 is used to implement the methods of the present invention in one embodiment. However, embodiments of the present invention are not limited to specific software and hardware configurations. Computer system 1400 can receive data comprising client application messages from computer 150 and server 103 used by client business, through a network 130 such as the Internet, and appropriate links 142, such as wired or wireless ones, and its network interface 1402. It can of course transmit data back to client business application over the same routes.

Computer system 1400 carries out the methods of the present invention when its processor 1404 processes instructions contained in its main memory 1410. Another computer-readable medium, such as its storage device 1408, may read these instructions into main memory 1410 and may do so after receiving these instructions through network interface 1402. Processor 1404 further processes data according to instructions contained in its storage device 1408. Data is relayed to appropriate elements in computer system 1400 through its bus 1406. Instructions for computer system 1400 can also be given through its input device 1416 and display 1414.

“Computer-readable medium” refers to any medium that provides instructions to processor 1404, comprising volatile, non-volatile, and transmission media. Volatile media comprise dynamic memory, such as main memory 1410. Non-volatile media comprise magnetic, magneto-optical, and optical discs, such as storage device 1408. Transmission media comprise a wide range of wired and unwired transmission technology, comprising cables, wires, modems, fiber optics, acoustic waves, such as radio waves, for example, and light waves, such as infrared, for example. Typical examples of widely used computer-readable media are floppy discs, hard discs, magnetic tape, CD-ROMs, punch cards, RAM, EPROMs, FLASH-EPOMs, memory cards, chips, and cartridges, modem transmissions over telephone lines, and infrared waves. Multiple computer-readable may be used, known and not yet known, can be used, individually and in combinations, in different embodiments of the present invention.

Alternate Embodiments

The previous extended description has explained some of the alternate embodiments of the present invention. It will be apparent to those skilled in the art that many other alternate embodiments of the present invention are possible without departing from its broader spirit and scope. For example, other embodiments of the present invention are possible where the elements of the system are widely and diversely dispersed on different servers.

It will also be apparent to those skilled in the art that different embodiments of the present invention may employ a wide range of possible hardware and of software techniques. For example the communication between a provider and client computers could take place through any number of links, including wired, wireless, infrared, or radio ones, and through other communication networks beside those cited, including any not yet in existence.

Also, the term computer is used here in its broadest sense to include personal computers, laptops, telephones with computer capabilities, personal data assistants (PDAs) and servers, and it should be recognized that it could include multiple servers, with storage and software functions divided among the servers. A wide array of operating systems, compatible e-mail services, Web browsers and other communications systems can be used to transmit messages among client applications and Web services.

Furthermore, in the previous description the order of processes, their numbered sequences, and their labels are presented for clarity of illustration and not as limitations on the present invention.

1. A method for providing dynamic learning to a student for a subject matter, the method comprising
conducting a pre-assessment of the student, the pre-assessment comprising
determining the cognitive learning styles of the student, and
determining the student's mastery of the subject matter;
providing a first plurality of lessons to the student by
configuring the content of the first plurality of lessons based on the learning styles of the student, and
targeting a plurality of cognitive learning styles selected from the set comprised of linguistic intelligence, logical-mathematical intelligence, spatial intelligence, musical intelligence, intrapersonal intelligence, bodily-kinesthetic intelligence, interpersonal intelligence, and naturalist intelligence;
conducting a mid-assessment of the student, the mid-assessment comprising
validating the cognitive learning styles of the student, and
determining the student's mastery of the content of the first plurality of lessons;
providing a second plurality of lessons to the student by
configuring the content of the second plurality of lessons based on the validated learning styles of the student, and
targeting a plurality of cognitive learning styles selected from the set comprised of linguistic intelligence, logical-mathematical intelligence, spatial intelligence, musical intelligence, intrapersonal intelligence, bodily-kinesthetic intelligence, interpersonal intelligence, and naturalist intelligence; and
conducting a post-assessment of the student, the post-assessment comprising
determining the student's mastery of the content of the first plurality of lessons and the content of the second plurality of lessons.

2. The method of claim 1 wherein providing a first plurality of lessons further comprises for each lesson in the first plurality of lessons
developing a lesson objective, such that the lesson objective identifies at least one specific skill that the student will develop, the lesson objective comprising at least one concept;
presenting the lesson objective concept;
presenting at least one analogy of the concept;
enabling internalization of the concept and the analogy through self reflection;
communicating in a chat room by posting responses to topic questions and sharing of best practices; and
summarizing the concept.

3. The method of claim 2 wherein presenting a lesson objective further comprises
presenting the lesson objective with text and voice-over text, thereby targeting linguistic intelligence and logical-mathematical intelligence.

4. The method of claim 2 wherein presenting at least one analogy of the concept further comprises
presenting a nature video thereby targeting natural intelligence.

5. The method of claim 2 wherein presenting at least one analogy of the concept further comprises
presenting a laugh-and-learn animated situational depiction thereby targeting linguistic intelligence, interpersonal intelligence, spatial intelligence and musical intelligence.

6. The method of claim 2 wherein enabling internalization of the concept and the analogy through self reflection further comprises
providing simulations of games thereby targeting intrapersonal intelligence, bodily-kinesthetic intelligence, spatial intelligence, linguistic intelligence, musical intelligence, and logical-mathematical intelligence.

7. The method of claim 2 wherein identifying a specific skill that the student needs to develop further comprises
developing an online experience chart, such that the experience chart guides the student over time to change a habit or develop the identified skill, thereby targeting linguistic intelligence, logical-mathematical intelligence, spatial intelligence, and intrapersonal intelligence.
